(19) United States
(12) Patent Application Publication
(10) Pub. No.: US 2013/0171734 A1
(43) Pub. Date: Jul. 4, 2013

(54) Method of Measuring Moisture Content in Lithium Secondary Battery Electrolyte and Analytical Reagent Composition Used in the Same

(71) Applicant: Soulbrain Co., Ltd., Seongnam-si (KR)

(72) Inventors: Suk Hwan Youn, Gongju-si (KR); Chong Oh Kim, Yeongi-gun (KR)

(73) Assignee: SOULBRAIN CO., LTD., Seongnam-si (KR)

(21) Appl. No.: 13/716,374

(22) Filed: Dec. 17, 2012

(30) Foreign Application Priority Data
Dec. 28, 2011 (KR) 10-2011-0144414
Nov. 6, 2012 (KR) 10-2012-0124783

(51) Int. Cl. G01N 31/16

(52) U.S. Cl. CPC G01N 31/168
USPC 436/42

(57) ABSTRACT

Provided is a reagent composition for measuring moisture content in a lithium secondary battery electrolyte, more particularly, a reagent composition for measuring moisture content in a lithium secondary battery electrolyte, containing imidazole, iodine, sulfur dioxide, and an amide based solvent, so that the reagent composition can suppress side reactions to thereby accurately measure a small amount of moisture content.

### CROSS-REFERENCE TO RELATED APPLICATIONS

This application claims priority under 35 U.S.C. §119 to Korean Patent Application No. 10-2011-0144414, filed on Dec. 28, 2011, No. 10-2012-0124783, filed on Nov. 6, 2012, in the Korean Intellectual Property Office, the disclosure of which is incorporated herein by reference in its entirety.

### TECHNICAL FIELD

The following disclosure relates to a method of measuring moisture content in a lithium secondary battery electrolyte and an analytical reagent composition used in the same.

### BACKGROUND

With the recent increase in the use of a lithium secondary battery in a mobile phone, a hybrid electric car, or the like, a lithium secondary battery electrolyte has been actively studied and developed.

For a current material widely used as the lithium secondary battery electrolyte, a lithium salt, such as, LiPF₆, lithium bis(oxaleto)borate (LiBOB), or the like, is dissolved in a carbonate based solvent such as ethylene carbonate, dimethyl carbonate, and ethylmethyl carbonate, or the like (see, Korean Patent Laid-Open Publication Nos. 10-2008-0000595 and 10-2011-0058507 and Korean Patent No. 10-0585947).

It is important to maintain the quality of this lithium secondary battery electrolyte to be uniform, and contents of moisture, hydrofluoric acid (HF), and anions are important factors for analysis. The reason is that, even though a trace of moisture and anionic components (Cl⁻, SO₄, or the like) are contained in an electrolyte, they react with a lithium salt such as LiPF₆ or LiBF₄ of electrolytic components of the lithium secondary battery to produce vapor or free-state HF and HCl, which cause the battery to explode. Therefore, the electrolyte is required to contain HF and moisture of several ppm or less. Thus, the quality test is performed by measuring moisture and hydrofluoric acid contents in the lithium secondary battery electrolyte.

However, in the case where lithium bis(oxaleto)borate called LiBOB is contained in the lithium secondary battery electrolyte, it is difficult to measure the moisture content by using a titrating analysis method known in the related art.

The Karl Fischer reagent is generally used to measure the moisture content.

Karl Fischer moisture measurement is a chemical volumetric analysis by dissolving a homogeneous sample in a solvent for Karl Fischer titration containing methanol or extracting moisture from the sample with the solvent, titrating it with a Karl Fischer reagent of which a titer is previously obtained, and then calculating the amount of moisture from consumption of the Karl Fischer reagent which chemical-equivalently reacts with the moisture.

The Karl Fischer reagent is a russet liquid where iodine (I₂), sulfur dioxide (SO₂), and pyridine are dissolved in methanol, and quantitatively reacts with moisture to consume I₂.

H₂O+I₂+SO₂+3C₅H₅N→2C₂H₅NHI+C₂H₅NSO₃ (1)

C₂H₅NSO₃+CH₃OH→C₅H₅NHSO₄CH₃ (2)

According to the titration method, the moisture contained in the sample is extracted with dehydrated methanol, and then titrated with the Karl Fischer reagent. Here, the end point for titration is indicated by the coloring due to an excessive amount of iodine, and is determined by potential-difference titration, current titration, or the like. Here, the pyridine is used to evade the loss of sulfur dioxide from the reagent, protect addition compounds generated during the reaction, and help the reaction to completely advance. In addition, the methanol serves as a non-aqueous solvent.

In a general electrolyte for a secondary battery, the main components of most solvents, such as, ethylene carbonate, ethylmethyl carbonate, and the like, have a ketone group. The electrolyte sub-reacts with methanol in the general Karl Fischer reagent to induce side reactions, such as, formation of acetal and ketal, generation of bisulphite, and the like, and hence, a Karl Fischer reagent for removing a sub-reaction, (Aldrich Company, Hydranal AK Solution or the like) has been used. This ketone-removing Karl Fischer reagent is composed of 1H Imidazole monohydridide, Imidazole hydrobromide, sulfur dioxide, 2-Methoxyethanol, Chloroform, 2,2,2-Trifluoroethanol, Imidazole, and Iodine, and is used to analyze a small amount of moisture in the electrolyte for a secondary battery.

The ketone-removing Karl Fischer reagent also contains alcohol, and the electrolyte for a secondary battery containing lithium bis(oxaleto)borate called LiBOB generates moisture through a sub-reaction with alcohol in the ketone-removing Karl Fischer reagent as follows:

Li(C₄O₈B)+2CH₃OH→(C₂O₄)BOLi+(CH₃OCO)₂+H₂O

Li(C₄O₈B)+2(CH₃OCH₂OCH₃OH)→(C₂O₄)BOLi+(CH₃OCH₂CH₃OCO)₂+H₂O)

Therefore, a very small amount of moisture cannot be measured by the existing ketone-removing Karl Fischer reagent. However, all the Karl-Fischer reagents currently on the markets contain alcohol, and thus the moisture content in the electrolyte for a secondary battery containing the LiBOB cannot be accurately measured.

Therefore, in order to accurately measure the moisture content in the lithium secondary battery electrolyte containing LiBOB, a reagent composition and an analyzing method for preventing generation of water need to be developed.

### PATENT DOCUMENTS

(Patent Document 1) Korean Patent Laid-Open Publication No. 10-2008-0000595 (Jan. 1, 2008)
(Patent Document 2) Korean Patent Laid-Open Publication No. 10-2011-0058507 (Jun. 1, 2011)
(Patent Document 3) Korean Patent No. 10-0585947 (May 25, 2006)

### SUMMARY

An embodiment of the present invention is directed to providing a new analysis method for measuring moisture content in a lithium secondary battery electrolyte and an analytical reagent composition used in the same.

Specifically, an embodiment of the present invention is directed to providing a new analytical reagent composition for measuring moisture content, not containing alcohol. For this reason, the new analysis method according to the present invention prevents generation of water, which is a sub-reactant due to reaction of the lithium secondary battery electrolyte containing LiBOB with the Karl-Fischer reagent, and thus, it is substantially possible to accurately measure the moisture content in the electrolyte, resulting in excellent precision and accuracy analysis.

Another embodiment of the present invention is directed to providing an analytical reagent composition for measuring moisture content in a lithium secondary battery electrolyte.

The present invention relates to a reagent composition used in measuring moisture content in a lithium secondary battery electrolyte. The reagent composition of the present invention is characterized by not containing alcohol, not inducing a sub-reaction, and measuring a small amount of moisture in a lithium secondary battery electrolyte.

In one general, a reagent composition for measuring moisture content in a lithium secondary battery electrolyte includes imidazole, iodine, sulfur dioxide, and an amide based solvent.

The reagent composition may be composed of a combination of an anolyte and a catholyte, and here,

the anolyte preferably containing 1˜3M of imidazole, 0.1˜2M of iodine, and 0.1˜2M of sulfur dioxide and the catholyte containing 0.1˜2M of imidazole, 0.1˜2M of iodine, and 0.1˜2M of sulfur dioxide. Here, an amide based solvent may be preferably used as a solvent.

The anolyte and the catholyte each may further contain 0.002˜0.004 mg of water per 1 ml thereof.

The reagent composition may be used in a Karl Fischer moisture measurement method.

All the stages from manufacturing the reagent composition to measuring by using the reagent composition are preferably performed in a closed room where moisture content is controlled to be 10 ppm or less, so that the reagent composition does not react with moisture in the air. Therefore, the stages are preferably performed within a glove box where the temperature and the moisture content are uniformly controlled.

### DETAILED DESCRIPTION OF EMBODIMENTS

Hereinafter, the present invention will be described in more detail.

In the present invention, as the lithium secondary battery electrolyte, any electrolyte that can contain a lithium salt, such as LiPF₆, LiBF₄, or the like, may be used without limitation. The present invention may be useful in measuring hydrofluoric acid (HF) content in an electrolyte. In particular, the present invention may be useful in measuring HF the hydrofluoric acid content in the lithium secondary battery electrolyte, containing a lithium salt such as LiPF₆, LiBF₄, or the like, and lithium bis(oxaleto)borate (LiBOB). That is, as the lithium bis(oxaleto)borate (LiBOB) reacts with alcohol in the Karl Fischer solution to generate water, it is difficult to accurately measure the content of moisture contained in the electrolyte. However, the reagent composition of the present invention allows the moisture content to be accurately measured.

The present invention is directed to an analytical reagent composition used for Karl Fischer titration, and an analytical reagent composition containing iodine, sulfur dioxide, imidazole as a buffer solution, and an amide based solvent as a solvent. Here, in the case where water is added to induce a forward reaction at the time of preparing the analytical reagent composition, more accurate results can be obtained. Specifically, when 0.002˜0.004 mg of water per 1 ml of the analytical reagent is added, the Karl Fischer reaction may occur as follows.

The Karl Fischer titration is as follows:

ROH+SO₂+R′N---->[R′NH]SO₃R

H₂O+I₂+[R′NH]SO₃R+2R′N---->[R′NH]SO₄R+2[R′NH]I

(wherein, R and R′ each are independently (C1-10)alkyl or (C6-C20)aryl.)

A general Karl Fischer reagent induces the above reaction in the presence of a non-aqueous solvent, specifically, methanol or the like. Pyridine is mainly used for a quantitative reaction. Main components of the Karl Fischer reagent may include iodine (I₂), sulfur dioxide (SO₂), pyridine as a buffer, and methanol as a solvent. As the methanol, methanol containing moisture is added for the forward reaction.

According to the Faraday law, 2×96485A·sec of electricity quantity is needed to generate 1 mole of iodine. 1 mole of the thus generated iodine reacts with 1 mole of water, and the generated I₂ has the μmol unit, and thus is suitable to measure a small amount of moisture.

In addition, in order to measure the moisture content in a composition having a functional group such as ketone or aldehyde, a sub-reaction may be suppressed by using 2-methoxyethanol, 2-chloroethanol, trifluoroethanol, or the like, instead of methanol. However, the foregoing solvents are also alcohols, and these alcohols may react with LiBOB in the lithium secondary battery electrolyte to generate moisture, that is, may induce a sub-reaction.

Therefore, the present invention is characterized by providing a new reagent composition for measuring the moisture content in the lithium secondary battery electrolyte, and more specifically the lithium secondary battery electrolyte containing LiBOB.

The present inventors studied the substitution for the existing solvent such as alcohols, and found that the use of amide based solvent does not induce a sub-reaction and the use of imidazole instead of pyridine of the related art allows easy measurement of a small amount of moisture content without inducing of the sub-reaction.

Specifically, the reagent composition for measuring moisture content in a lithium secondary battery electrolyte according to the present invention may include imidazole, iodine, sulfur dioxide, and an amide based solvent.

More specifically, the reagent composition includes 0.1˜3M of imidazole, 0.1˜2M of iodine, 0.1˜2M of sulfur dioxide, and an amide based solvent as a solvent.

In the present invention, the imidazole is used to buffer a reaction stably by neutralizing acid generated at the time of the Karl Fischer reaction, and is preferably contained in 0.1˜3M.

The iodine is used to measure the loss of current at the time of measuring the moisture content by using a potential difference, and is preferably contained in 0.1˜2M. If the iodine contained is below 0.1M, it is difficult to generate sufficient amount of I₂, and thus the reaction may be difficult to advance. If the iodine contained is above 2M, I₂ is excessively titrated, and thus a separate procedure for removing I₂ may be needed.

The sulfur dioxide is preferably contained in 0.1˜2M. The above range may satisfy the pH range at which the Karl Fischer reaction occurs, pH 4˜7.

Specific examples of the amide based solvent may include formamide, N-methyl formamide, N,N-dimethyl formamide, acetamide, N-methyl acetamide, N-dimethyl acetamide, N-methylpyrrolidone, and the like. The amide based solvent (N-methyl formamide) serves to analyze only residual moisture in a sample, without being decomposed.

In addition, the reagent composition may further include 0.002˜0.004 mg of water per 1 ml thereof, to induce a forward reaction.

The reagent composition of the present invention may be used in the Karl Fischer moisture measurement method, and this may be measured by using the potential difference measurement apparatus. Apparatuses used herein may be 756KF coulometer and 870KF titrino Plus by Methrohm Company, MKC-510N by KEM Company, and the like, but is not limited thereto.

The potential difference measurement apparatus includes a measuring cell. The measuring cell is divided into an anode compartment and a cathode compartment by a diaphragm, and a platinum electrode is installed at each of the compartments. The diaphragm serves to prevent reagents filling the respective compartments from being mixed with each other.

The measurement of moisture content occurs at the anode compartment. When anolyte, which is a reagent filling the anode compartment, is stirred to allow a current to flow, I₂ is generated at the platinum electrode of the anode compartment, and the generated I₂ reacts with water present in the anode compartment. When all the moisture reacts with the generated I₂ and excessive I₂ remains, the equivalent point is recognized by another double Pt electrode, and thus the current is automatically shut off. The moisture content is calculated from the amount of current supplied in order to generate I₂, which quantitatively reacts with water to the equivalent point (Q=IT).

In order to determine moisture content, an anolyte needs to fill the anode compartment and a catholyte, which has a similar composition as the anolyte, needs to fill the cathode compartment.

Therefore, the reagent composition of the present invention may be composed of a combination of an anolyte and a catholyte. The anolyte may contain 1˜3M of imidazole, 0.1˜2M of iodine, and 0.1˜2M of sulfur dioxide and the catholyte may contain 0.1˜2M of imidazole, 0.1˜2M of iodine, and 0.1˜2M of sulfur dioxide. An amide based solvent may be used as a solvent.

Here, the catholyte is preferably inputted in about 90˜110 ml, and the anolyte is preferably inputted in about 4˜6 ml.

The anolyte and the catholyte each may further contain 0.002˜0.004 mg of water per 1 ml thereof.

The reagent composition of the present invention is preferably controlled to have a moisture content of 10 ppm or less, to thereby prevent reaction with moisture in the air. More preferably, the reagent composition is prepared in a glove box where temperature and moisture content are uniformly controlled, and the moisture content thereof is measured.

Hereinafter, the present invention will be described in more detail with reference to the embodiments. However, the following examples are merely examples of the present invention, and the scope of the present invention is not limited to the following examples.

### Preparative Example 1

### Preparation of Electrolyte (1) for Lithium Secondary Battery

A composition containing 31.50 wt % of ethylene carbonate, 15.50 wt % of diethyl carbonate, 40.00 wt % of ethylmethyl carbonate, 12.80 wt % of LiPF₆, and 0.2 wt % of LiBF₄ was prepared.

### Preparative Example 2

### Preparation of Electrolyte (2) for Lithium Secondary Battery

A composition containing 31.30 wt % of ethylene carbonate, 15.50 wt % of diethyl carbonate, 40.00 wt % of ethylmethyl carbonate, 12.80 wt % of LiPF₆, 0.2 wt % of LiBF₄, and 0.2 wt % of LiBOB was prepared.

### Preparative Example 3

### Preparation of Electrolyte (3) for Lithium Secondary Battery

A composition containing 22.041 wt % of ethylene carbonate, 29.93 wt % of diethyl carbonate, 33.97 wt % of ethylmethyl carbonate, 13.04 wt % of LiPF₆, 0.50 wt % of 1-propene-1,3-sultone, and 0.5 wt % of LiBOB was prepared.

Examples below were carried out in a glove box where the moisture content was controlled to be 10 ppm or less. Each sample was controlled to have a moisture content of 1 ppm or less, and then used in the experiment.

Comparative Examples were carried out in a general room having a temperature of 25° C. and a humidity of 17%.

### Example 1

### 1) Preparation of Anolyte

An anolyte was prepared by dissolving imidazole 3M (40.8462 g), iodine 0.55M (27.9188 g), and sulfur dioxide 0.15M (1.922 g) in 150 ml of N-methyl formamide.

### 2) Preparation of Catholyte

A catholyte was prepared by dissolving imidazole 0.5M (6.8077 g), iodine 0.25M (12.6904 g), and sulfur dioxide 0.58M (7.40 g) in 200 ml of N-methyl formamide.

### 3) Measurement of Moisture Content

The moisture content in the electrolyte of Preparative Example 1 was measured, and MKC-510N by KEM Company was used as the experimental equipment. Equipment constitution and measurement conditions were as follows.

Equipment Constitution: Detection electrode, Diaphragm inner Burette electrode, Vessel

Measurement Method and Conditions: Drift Stop: 0.1 μg/s, Waiting: 15 sec, Stable: 0.03 μg/s

Details for the measurement method were as follows.

First, it was confirmed on a screen of the equipment whether the Drift value was 0.1 μg/s or less, and stabilized. After the confirmation, a dried syringe was filled with 1 ml of a sample to be analyzed, and weighted. The sample in the syringe was inputted into a Karl Fischer cell, and then an operation button was pressed.

The syringe which has been emptied after inputting of the sample was weighted. The difference date between initial weight and later weight was inputted into the equipment.

The measured results were tabulated in table 1.

### Example 2

### 1) Preparation of Anolyte

An anolyte was prepared by dissolving imidazole 3M (40.8462 g), iodine 0.55M (27.9188 g), and sulfur dioxide 0.15M (1.922 g) in 150 ml of N-methyl formamide.

### 2) Preparation of Catholyte

A catholyte was prepared by dissolving imidazole 0.5M (6.8077 g), iodine 0.25M (12.6904 g), and sulfur dioxide 0.58M (7.40 g) in 200 ml of N-methyl formamide.

### 3) Measurement of Moisture Content

The moisture content in the electrolyte of Preparative Example 2 was measured, and MKC-510N by KEM Company was used as the experimental equipment. Equipment constitution and measurement condition were as follows.

Equipment Constitution: Detection electrode, Diaphragm inner Burette electrode, Vessel

Measurement Method and Conditions: Drift Stop: 0.1 μg/s, Waiting: 15 sec, Stable: 0.03 μg/s

The measured results were tabulated in table 1.

### Example 3

### 1) Preparation of Anolyte

An anolyte was prepared by dissolving imidazole 3.0M (40.8462 g), iodine 0.55M (27.9188 g), and sulfur dioxide 0.19M (1.281 g) in 150 ml of N-methyl formamide.

### 2) Preparation of Catholyte

A catholyte was prepared by dissolving imidazole 0.5M (6.8077 g), iodine 0.25M (12.6904 g), and sulfur dioxide 0.58M (7.40 g) in 200 ml of N-methyl formamide.

### 3) Measurement of Moisture Content

The moisture content in the electrolyte of Preparative Example 3 was measured, and MKC-510N by KEM Company was used as the experimental equipment. Equipment constitution and measurement condition were as follows.

Equipment Constitution: Detection electrode, Diaphragm inner Burette electrode, Vessel

Measurement Method and Conditions: Drift Stop: 0.1 μg/s, Waiting: 15 sec, Stable: 0.03 μg/s

The measured results were tabulated in table 1.

### Comparative Example 1

The moisture content in the electrolyte of Preparative Example 1 was measured.

The moisture content was measured by using the Hydranal-AK reagent as a commercialized Karl Fischer reagent and using 759KF by Metrohm Company as experimental equipment. Equipment constitution and measurement condition were as follows.

Equipment Constitution: Detection electrode, Diaphragm inner Burette electrode, Vessel

Measurement Method and Conditions: relative Stop drift: 0.1 μg/s, Waiting: 15 sec, Stable: 0.6 μg/min

The measured results were tabulated in table 1.

### Comparative Example 2

The moisture content in the electrolyte of Preparative Example 2 was measured.

The moisture content was measured by using the Hydranal-AK reagent as a commercialized Karl Fischer reagent and using 759KF by Metrohm Company as experimental equipment. Equipment constitution and measurement condition were as follows.

Equipment Constitution: Detection electrode, Diaphragm-free Generate electrode, Vessel

Measurement Method and Conditions: Relative Stop drift: 20 μg/min, Waiting: 10 sec, Stable: 0.03 μg/s

The measured results were tabulated in table 1.

### Comparative Example 3

The moisture content in the electrolyte of Preparative Example 3 was measured.

The moisture content was measured by using the Hydranal-AK reagent as a commercialized Karl Fischer reagent and using 759KF by Metrohm Company as the experimental equipment. Equipment constitution and measurement condition were as follows.

Equipment Constitution: Detection electrode, Diaphragm-free Generate electrode, Vessel

Measurement Method and Conditions: Relative Stop drift: 20 μg/min, Waiting: 10 sec, Stable: 0.03 μg/s

The measured results were tabulated in table 1.

TABLE 1
(Unit: ppm)

| | | Comparative | |
|---|---|---|---|
| | Example | Example | Note |
| 1 | 13.273 | 13.2 | Electrolyte for Secondary battery |
| | | | (before addition of LiBOB) |
| 2 | 13.25 | Not measurable | Electrolyte for Secondary battery |
| | | | (after addition of LiBOB) |
| 3 | 4.073 | Not measurable | Electrolyte for Secondary battery |
| | | | (after addition of LiBOB) |

As can be seen from Table 1 above, it was confirmed that the use of the reagent composition of the present invention made it possible to measure the moisture content before and after addition of LiBOB.

However, it could be seen that the commercialized reagents as shown in Comparative Examples 2 and 3 made it impossible to measure the moisture content.

As set forth above, the reagent composition according to the present invention allows accurate measurement of a small amount of moisture content in a lithium secondary battery electrolyte susceptible to moisture, and provides high degree of precision and reproducibility therefor.

Further, the reagent composition of the present invention can suppress the generation of byproducts of the lithium secondary battery electrolyte, which is susceptible to moisture, and thus allows accurate measurement of the moisture content in the lithium secondary battery electrolyte.

What is claimed is:

1. A reagent composition for measuring moisture content, the reagent composition comprising imidazole, iodine, sulfur dioxide, and an amide based solvent.

2. The reagent composition of claim 1, wherein it is used to measure moisture content in a lithium secondary battery electrolyte.

3. The reagent composition of claim 2, wherein the lithium secondary battery electrolyte contains LiBOB.

4. The reagent composition of claim 1, wherein the amide based solvent is any one or a mixture of two or more selected from formamide, N-methyl formamide, N,N-dimethyl formamide, acetamide, N-methyl acetamide, N-dimethyl acetamide, and N-methylpyrrolidone.

5. The reagent composition of claim 1, wherein it is composed of a combination of an anolyte and a catholyte,
the anolyte containing 1˜3M of imidazole, 0.1˜2M of iodine, 0.1˜2M of sulfur dioxide and an amide based solvent as a solvent,
the catholyte containing 0.1˜2M of imidazole, 0.1˜2M of iodine, 0.1˜2M of sulfur dioxide and an amide based solvent as a solvent.

6. The reagent composition of claim 5, wherein the anolyte and the catholyte each further contain 0.002˜0.004 mg of water per 1 ml thereof.

7. The reagent composition of claim 1, wherein it is used in a Karl Fischer moisture measurement method.

8. The reagent composition of claim 1, wherein the moisture content is controlled to be 10 ppm or less.
